(19) United States
(12) Patent Application Publication
(10) Pub. No.: US 2010/0230266 A1
(43) Pub. Date: Sep. 16, 2010

(54) Configurable Electrical Outlet Receptacle

(76) Inventor: Daniel J. Vestyck, Macungie, PA (US)

Correspondence Address: Daniel Vestyck Jr., 6690 Hauser Road M303, Macungie, PA, 18062, US

(21) Appl. No.: 12/724,356

(22) Filed: Mar. 15, 2010

Related U.S. Application Data
(60) Provisional application No. 61/160,308, filed on Mar. 14, 2009.
(60) Provisional application No. 61/224,046, filed on Jul. 8, 2009.

(51) Int. Cl. H01R 13/70

(52) U.S. Cl. 200/51 R

(57) ABSTRACT

There is disclosed an electrical receptacle for connecting to an electrical distribution scheme, specifically, an improved standard electrical receptacle where one or both sockets are configurable and are user-configurable to be either continuously powered or connected to a switched wiring loop. In one embodiment, there is disclosed an electrical receptacle comprising: at least one receiving terminal; and at least one integrated switch comprising a common pole and at least one switched pole, wherein the common pole is connected to the receiving terminal and the at least one switched pole is connected to a current carrying or positive “hot” wire.

This application claims priority to U.S. Provisional Application Nos. 61/160,308, filed on Mar. 15, 2009, and 61/224,046, filed on Jul. 8, 2009, both of which are incorporated herein by reference in their entirety.

That application is related to residential and commercial electrical wiring systems and receptacles; and, more particularly, to an improved electrical receptacle that is configurable by the user. The present invention also relates to a method for electrically wiring a building or similar structure using the disclosed electrical receptacle.

In typical building wiring installations, electrical outlets in rooms such as bedrooms, dining rooms and living rooms are located around the perimeter of the room. Most receptacles are “ganged” in either duplex (2) or quad (4) arrangement. Common electrical receptacles have two sockets that can be wired in parallel on a single circuit or separated so that each socket is on a different circuit or to have one of the sockets wired directly to and controlled by a wall switch.

The problem with current household receptacle is that the location of the switched sockets is determined when they are installed and the end user is limited to this configuration. In many cases the location of a switched socket is not convenient or not in a location desired by the user for appliances such as lighting products like table lamps and floor lamps. In other instances a switched outlet may be in a location where the user desires more continuously powered outlets and cannot use the switched outlet because a loss of power may adversely affect the performance of the appliance (example clock radio or TV). But since the wall-switched outlet wiring is embedded in the wall there is no easy option other than running an extension cord around or across the room to the desired location. Thus, there is a need for an electrical outlet that is configurable by the end user.

### SUMMARY OF THE INVENTION

To solve the foregoing problems, there is disclosed an improved standard electrical receptacle where one or both sockets are configurable and are user-configurable to be either continuously powered or connected to a switched wiring loop. With the disclosed design, each electrical outlet in the room is wired both to a continuously powered circuit and a switched power circuit like a room wall switch or switches. The electrical outlet according to the disclosed invention has a built-in switch which selects the positive or hot leg of the wiring from either the continuously powered or switched circuit. In this arrangement any one or combinatory group of outlets can be controlled from the wall switch giving the user the flexibility to place the electrical appliance(s) to be controlled next to any of the outlets in the room.

The invention could be used in new construction, e.g., installed when the house or building is being built, but in certain embodiments, the receptacle described herein can also be installed into existing building to add flexibility to current electrical wiring. The invention is not limited to residential applications where 1 to 2 integrated switches may be useful. For commercial applications the number of integrated switches and receptacles can be larger.

Aside from the subject matter discussed above, the present disclosure includes a number of other exemplary features such as those explained hereinafter. It is to be understood that both the foregoing description and the following description are exemplary only.

### BRIEF DESCRIPTION OF THE DRAWINGS

The accompanying figures are incorporated in, and constitute a part of, this specification.

FIG. 1 is a schematic of a basic configurable outlet concept according to the present disclosure showing the outlet's integrated switch in the traditional two positions (A and B).

FIG. 2 is an embodiment of the present invention, which shows two appliances that are switched while one (#3) is configured to the “always-on” state.

FIG. 3 is an additional embodiment of the present invention showing appliances in locations 1 and 3 that are switched.

FIG. 4 is another embodiment of the present invention showing that the appliance found in location 1 is the only one switched, while appliances 2 and 3 are on.

FIG. 5 is a further embodiment of the invention which includes multiple integrated switches, such as may be useful in commercial applications.

FIG. 6 is a schematic of the front side of a receptacle according to the present disclosure showing both a push button interface (5) and switch position indicator (6).

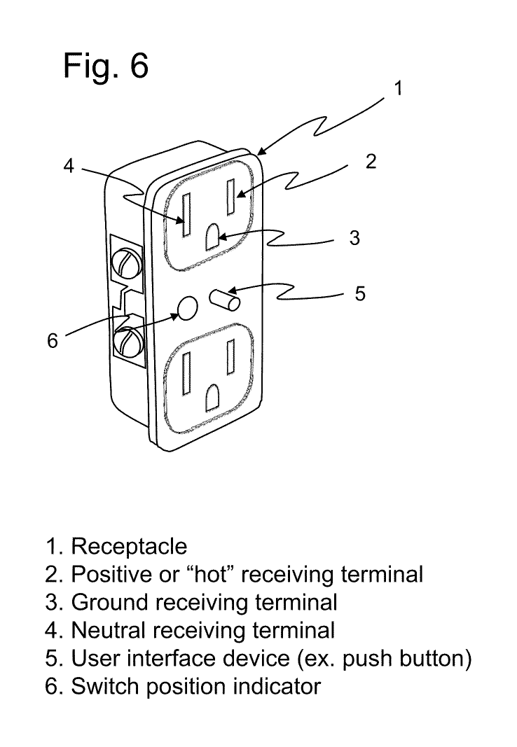

FIG. 7 is a schematic of the back side of the receptacle of FIG. 6 showing the wiring terminals for “hot” continuous power, “hot” switched power“, neutral and ground.

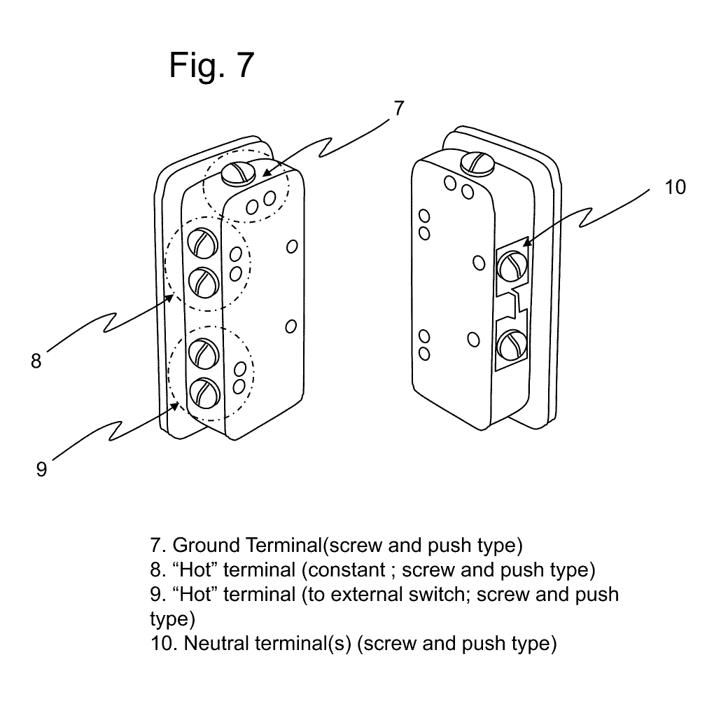

### DETAILED DESCRIPTION OF THE INVENTION

Definitions

As used herein, the term “blade” is meant to encompass the male part of an electrical connector. It can also be referred to as the “pin,” “prong,” or “plug” of the connector.

The term, “receptacle,” is meant to encompass the female part of an electrical connector. It can also be referred to as a “socket” or “outlet.”

The term “common pole” is meant to encompass one terminal of a multi-pole switch that is always connected and is common to the closed power circuit. It is sometimes defined as the “pole” in switch definition.

The term “switched pole” is meant to encompass a terminal of a multi-pole switch that can be selected or de-selected as part of the closed power circuit. It is sometimes defined as the “throw” in switch definition.

The term “receiving terminal” is meant to encompass a single part or port of the receptacle that accepts a single blade or prong.

The phrase “change the state” means choosing a switch position, such as selecting path A or path B.

The contacts in the above-mentioned male and female components may be made of steel or brass, and may be plated with zinc, tin, or nickel. They can be made of any electrically conductive material.

In one embodiment, there is disclosed a device comprising a standard electrical receptacle for receiving either 2 prong or 3 prong electrical plugs with the following additions:

(1) an integrated latching AC power switch

(2) a mechanism for changing the state of the switch; and

(3) an additional positive terminal for wiring AC power to the receptacle.

In another embodiment the integrated switch is a single pole—double throw type, comprising three electrical contacts, one common and two switched contacts. The switch functions as what is commonly termed an “A-B Box”. The mechanism for changing the state of the switch is a simple pushbutton that can be accessed from the front surface of the receptacle. The additional positive terminal can be screw type or push type or the receptacle can be fitted with both.

The common contact of the integrated switch is internally connected to the “hot” or positive port on the receptacle for receiving a positive plug blade. The two, switched contacts of the switch are each connected to a separate positive wiring terminal on the receptacle for wiring in a format typically used on standards receptacles, such as screw terminals, push in type, and the like.

In this embodiment, one of the switched terminals would be wired to the “hot” leg of the room electrical circuit and the second switched terminal would be wired to a standard wall switch. In this arrangement the source of AC power being delivered to the receptacle can be “chosen” to be provided by A) the “hot” circuit in the room or B) a “switched” hot circuit provided by the wall switch.

In the simplest embodiment, the mechanism is a rod or pushbutton that can protrude through the front surface of the receptacle. In one state it moves the switch into a position where its common contact is connected to position A″ terminal and in the other state it moves the switch into a position where its common contact is connected to position “B” terminal.

Common household receptacles can have screw or push type terminals for connecting to the household wiring circuit. They commonly have a terminal for positive, neutral and ground wiring. In this invention there is an additional positive terminal which is independent from the first. A typical wiring scheme for this invention would have one of the positive terminals wired to the room “hot” circuit and the other would be wired to one of the terminals on a standard wall switch. The other terminal on the wall switch is typically wired to the “hot” or positive wiring in the room.

Thus, in one embodiment there is disclosed an electrical receptacle for connecting to an electrical distribution scheme. In one embodiment, the electrical receptacle comprises: at least one receiving terminal; and at least one integrated switch comprising a common pole and at least one switched pole, wherein the common pole is connected to the receiving terminal of the receptacle and the at least one switched pole is connected to a current carrying or positive “hot” wire. As one skilled in the art would appreciate, the live contact carries current from the source to the load.

The inventive electrical receptacle could be of the same format as standard household outlets and might resemble a GFI outlet, which has a button in the center but for a different application. In this invention, a button on the face of the outlet would allow the user to actuate the switch thereby configuring which hot or positive leg is directed to the receptacle's “hot” receiving terminal. In this embodiment, the outlet (duplex) would have an additional wiring terminal compared to standard outlets. This additional terminal would be wired to the hot or positive wire coming from a single wall switch or two switches in a two-way arrangement. When wiring a new room, every outlet essentially gets wired to both the wall switch circuit and the continuously powered circuit but the user can select which outlets function from the wall switch. Additionally the user can configure both sockets on an outlet to be always “on” if needed. Such a configuration provides for extra outlets compared with current electrical outlet design used in a switch application.

The electrical receptacle may comprise a plurality of receiving terminals for standard blade type electrical components and appliances.

In some embodiment, the receptacles and plugs also include a third contact for a connection to earth ground, intended to protect against insulation failure of the connected device. For example, in one embodiment, at least one of the receiving terminals is connected to or in contact with the ground wiring of the electrical distribution scheme for the purpose of providing a ground path for electrical components.

In one embodiment, at least one of the receiving terminals is connected to or in contact with the neutral wiring of the electrical distribution scheme for the purpose of providing a neutral path for electrical components, e.g., the neutral returns current to the source.

The integrated switch used with the inventive electrical receptacle may comprise various types, depending on the end use. For example, the at least one integrated switch described herein may comprise a single pole double throw, a double pole double throw of latching type.

In one embodiment, the electrical receptacle described herein may further comprise at least one second switched pole that is connected to an external switching device for user selection. For example, such a switching device may comprise a wall switch or dimmer switch.

In one embodiment, the disclosed electrical receptacle may further comprise an interface device on the external surface of the receptacle capable of allowing a user to change the state of said integrated switch. For example, the interface may comprise a pushbutton or a toggle button. In another embodiment, the interface device may comprise an electrical solenoid.

In one embodiment, the electrical receptacle described herein may further comprise a status indicator to convey the state of the switch, such as an incandescent light or a light emitting diode (LED).

In one embodiment, the status indicator may comprise a mechanical device that can convey a plurality of states. In another embodiment, the status indicator indicates the position of the device.

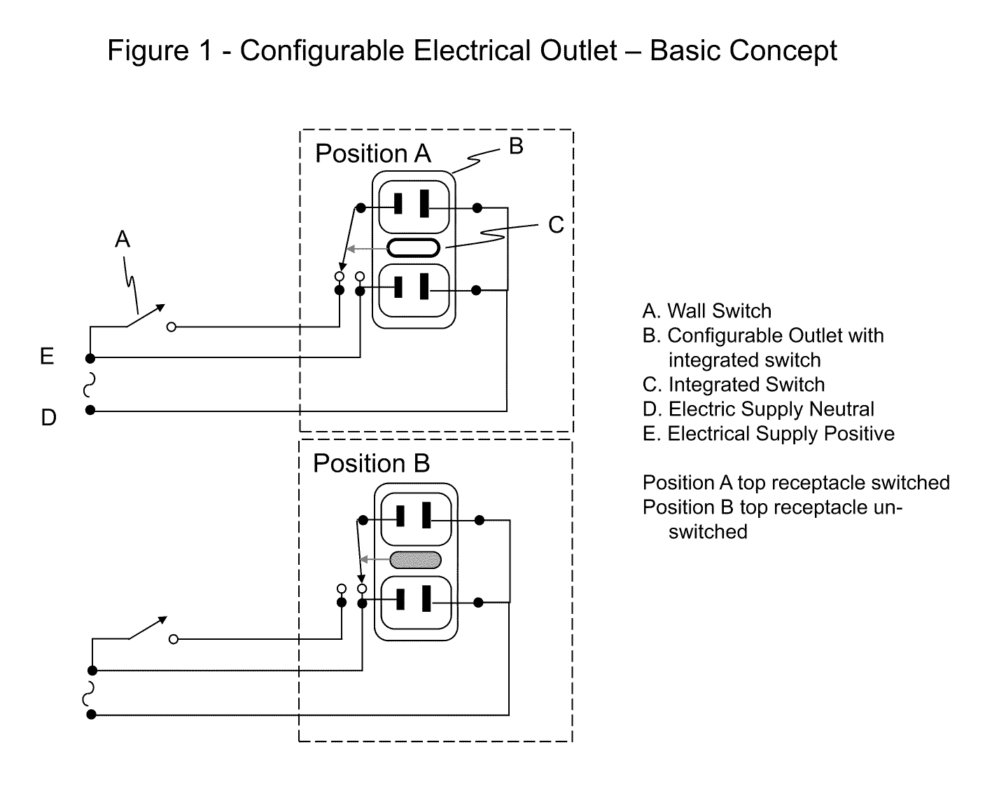

FIG. 1 describes the invention in its most basic design. The configurable outlet (B) is shown with the integrated switch (C) in each of its possible positions. Electrical power is supplied to a common point (E) for distribution to one or more receptacles. Power is supplied to the receptacle through two paths, 1) directly and 2) through a wall switch (A). The neutral wiring is connected to the negative side of the receptacle in typical fashion. Ground wiring is not shown for simplicity. In this description a single pole double throw switch is used to select the “hot” power source. The integrated switch's state is changed through mechanical means by the user. Non-limiting examples of such a mechanical device include a pushbutton, toggle button, rocker button, or the like. The top figure labeled “Position A” shows the electrical circuit where the top socket in the receptacle is powered by an external switch, such as a wall switch (A). The bottom socket in the receptacle is powered directly from the source (E) and is “always on.” In this arrangement the top socket is controlled by the external switch and the bottom is continuously powered.

The bottom figure labeled “Position B” shows the electrical circuit where the top socket in the receptacle is powered directly from the source (E) and is “always on.” Similarly, the bottom socket in the receptacle is powered directly from the source (E) and is “always on.” In this arrangement, both receptacles are continuously powered.

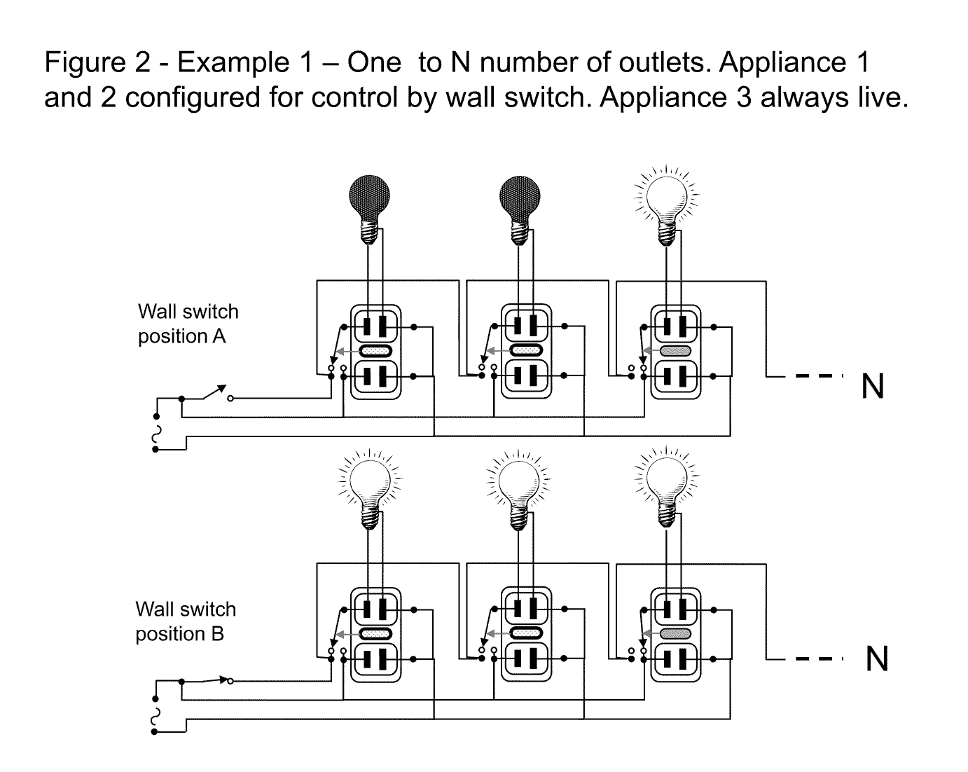

FIG. 2 shows the inventive concept extended to multiple receptacles powered by the same power source as one might see in a residential room. Three configurable outlets are wired identically. In this case the bottom socket of each receptacle is continually powered. However the top sockets' configurations vary. In this embodiment, receptacles #1 and #2 are configured as “switched” while receptacle #3 is configured in the “un-switched” mode.

A typical electrical appliance is represented by a light bulb as an example, however, it could be any electrical appliance, including but not limited to a television, light, radio, toaster, clock, etc.

The top figure in FIG. 2 (Wall Switch-Position A) shows the state of the appliances with the external switch (wall switch) in the OFF state. Since power is not supplied past the external switch neither appliance plugged into the top socket of receptacles #1 or #2 are on. However, the appliance plugged into the top socket of receptacle #3 is on because the state of the integrated switch is providing continuous power.

The bottom figure in FIG. 2 (Wall Switch-Position B) shows the state of the appliances with the external switch (wall switch) in the ON state. Since power is now supplied past the external switch both appliances plugged into the top socket of receptacles #1 or #2 are on. The appliance plugged into the top socket of receptacle #3 is on because the state of the integrated switch is providing continuous power and it is not affected by the position of the external switch.

In this embodiment, there are four available sockets that are continually powered for appliances that will not be switched.

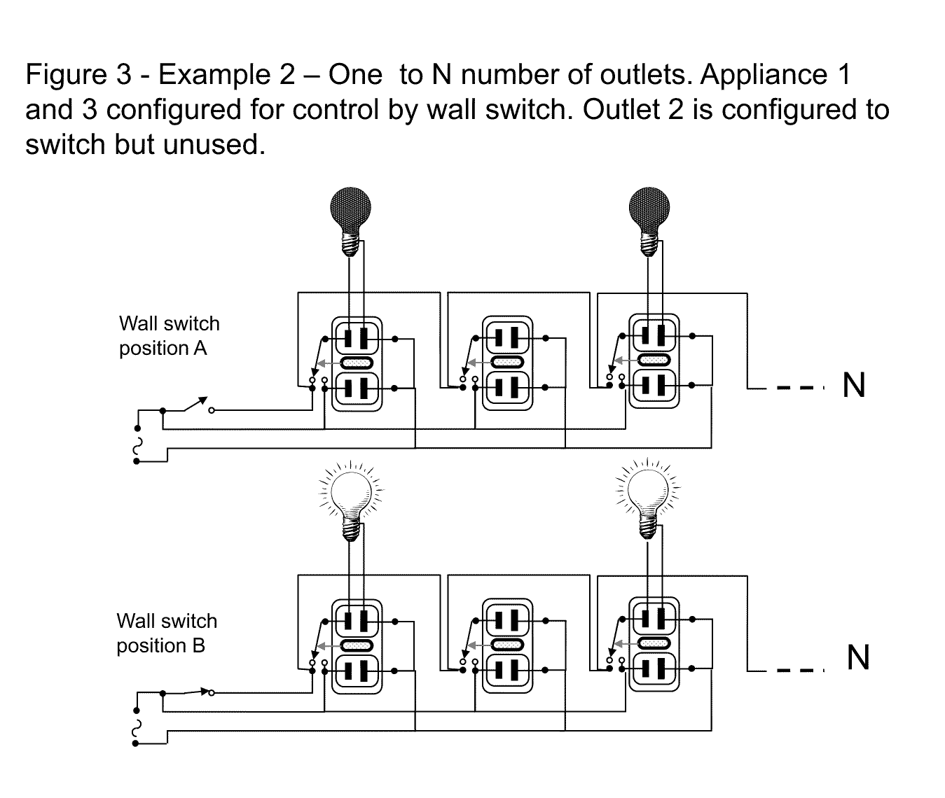

FIG. 3 shows the same wiring configuration as shown in FIG. 2 but with the receptacles configured differently. Again, three configurable outlets are wired identically. In this case the bottom socket of each receptacle is continually powered, however the top sockets' configurations vary and in this example all the receptacles are configured as “switched.”

A typical electrical appliance is represented by a light bulb as an example, however, it could be any electrical appliance, including but not limited to a television, light, radio, toaster, clock, etc.

The top figure in FIG. 3 (Wall Switch-Position A) shows the state of the appliances with the external switch (wall switch) in the OFF state. Since power is not supplied past the external switch neither appliance plugged into the top socket of receptacles #1 or #3 are on. No appliance is plugged into the top socket of receptacle #2.

The bottom figure in FIG. 3 (Wall Switch-Position B) shows the state of the appliances with the external switch (wall switch) in the ON state. Since power is now supplied past the external switch both appliances plugged into the top socket of receptacles #1 or #3 are on.

In this example there are three available sockets that are continually powered for appliances that will not be switched.

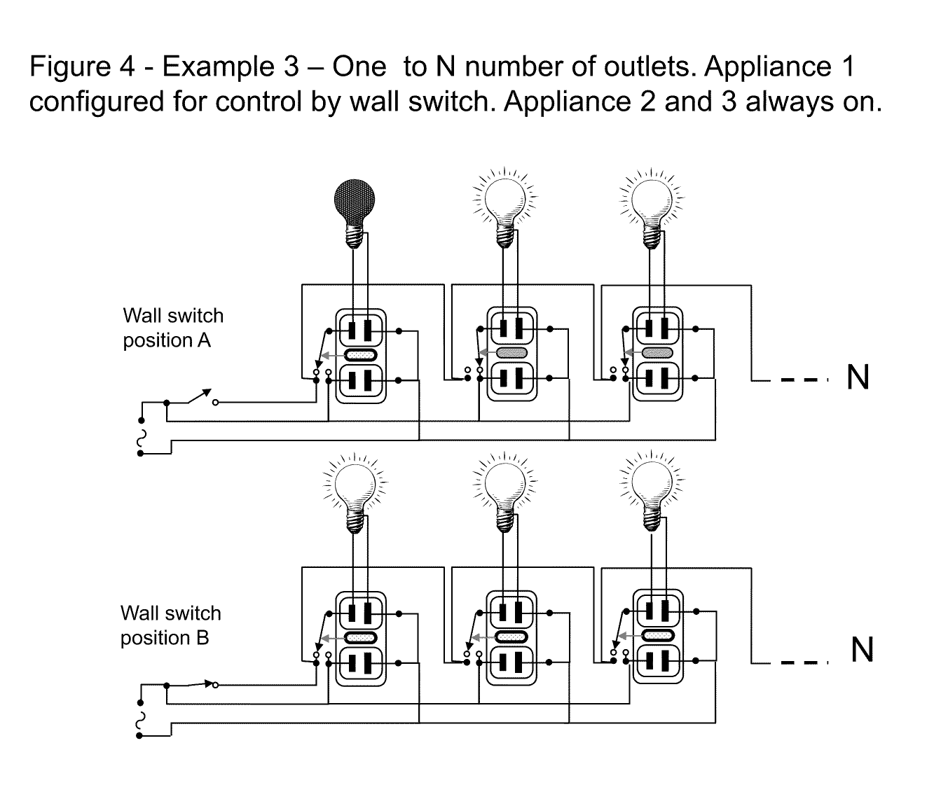

FIG. 4 shows the same wiring configuration as shown in FIG. 2 but with the receptacles configured differently. Three configurable outlets are wired identically. In this case the bottom socket of each receptacle is continually powered. However the top sockets' configurations vary and in this example only receptacle #1 is configured to be switched.

A typical electrical appliance is represented by a light bulb as an example, however, it could be any electrical appliance, including but not limited to a television, light, radio, toaster, clock, etc.

The top figure in FIG. 4 (Wall Switch-Position A) shows the state of the appliances with the external switch (wall switch) in the OFF state. Since power is not supplied past the external switch, the appliance plugged into the top socket of receptacle #1 is off. Both appliances in receptacles #2 and #3 are on due to the “un-switched” state of the receptacle.

The bottom figure in FIG. 4 (Wall Switch-Position B) shows the state of the appliances with the external switch (wall switch) in the ON state. Since power is now supplied past the external switch the appliance plugged into the top socket of receptacle #1 on.

In this example there are five available sockets that are continually powered for appliances that will not be switched.

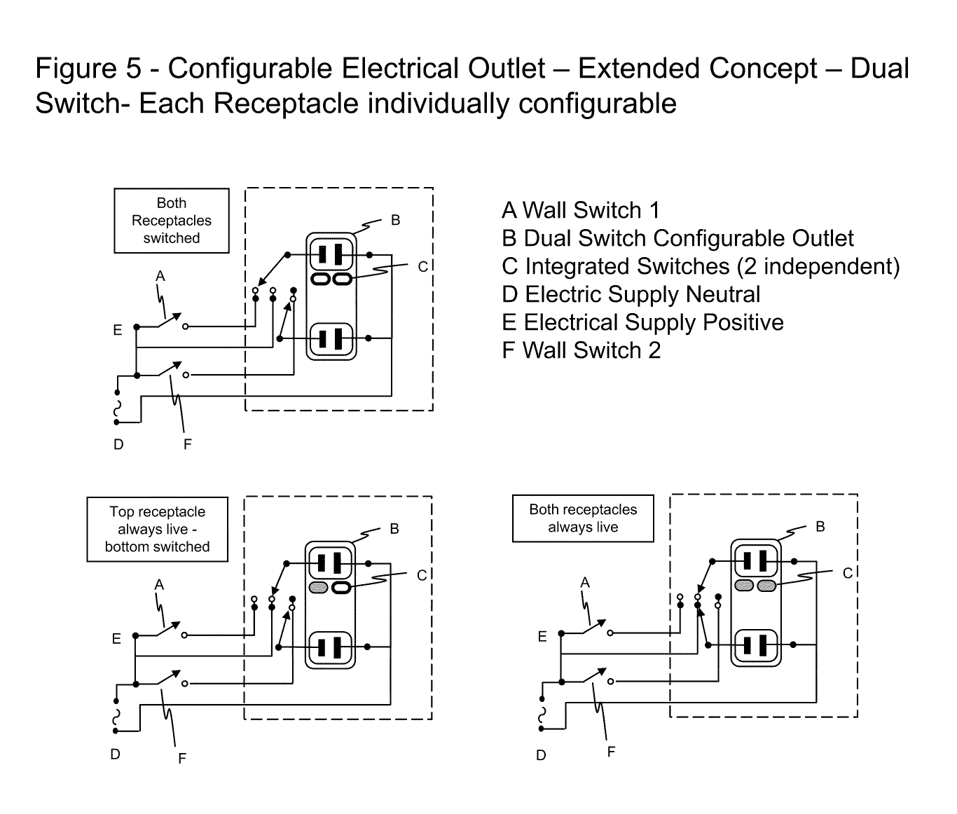

FIG. 5 shows an extension of the configurable outlet concept whereby two integrated switches are used and both the upper and lower socket of the configurable receptacle are configurable. In this arrangement there would be three independent positive power terminals on the receptacle. One terminal would be wired directly to the power source while the other two could be run through two separate external switches (i.e. wall switches) powered by the same power source (shown here) or an independent power source (not shown). The “Dual Configurable Outlet” (B) is shown with two integrated switches (C) in a subset of possible positions. Electrical power is supplied to a common point (E) for distribution to one or more receptacles. Power is supplied to the receptacle through three paths, 1) directly 2) through a wall switch (A) and a second wall switch (F). The neutral wiring is connected to the negative side of the receptacle in typical fashion. Ground wiring is not shown for simplicity. In this description two single pole double throw switches are used to select the “hot” power sources. The integrated switches' states are changed through mechanical means by the user (ie, pushbutton, toggle button, rocker button etc.).

The top figure labeled “Both receptacles switched” shows the electrical circuit where both sockets in the receptacle are powered by independent external switches (such as a wall switch) (A and F).

The bottom left figure in FIG. 5 labeled “Top receptacle always live- bottom switched” shows the electrical circuit where the top socket in the receptacle is powered directly from the source (E) and is “always on”. The bottom socket is “switched” and is powered only when external switch (F) is closed.

The bottom right figure in FIG. 5 labeled “Both receptacles always live” shows the electrical circuit where both sockets in the receptacle are powered directly from the source (E) and are “always on.”

It is to be appreciated that the receptacle described herein may be used in standard household configurations, or in industrial applications. Accordingly, the disclosed receptacles may be used at a voltage up to 600 V and a current up to 100 amps. In one embodiment, the electrical receptacle described herein may be used at a voltage ranging from 100 to 250V and a current ranging from 10 to 50 amps.

The specification and examples disclosed herein are intended to be considered as exemplary only, with a true scope and spirit of the invention being indicated in the following claims.

Other than in the examples, or where otherwise indicated, all numbers expressing quantities of ingredients, reaction conditions, analytical measurements, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the disclosure are approximations, unless otherwise indicated the numerical values set forth in the specific examples are reported as precisely as possible. Any numerical value, however, inherently contains certain errors necessarily resulting from the standard deviation found in their respective testing measurements.

What is claimed is:

1. An electrical receptacle for connecting to an electrical distribution scheme, said electrical receptacle comprising:
at least one receiving terminal; and
at least one integrated switch comprising a common pole and at least one switched pole, wherein said common pole is connected to said receiving terminal and said at least one switched pole is connected to a current carrying or positive “hot” wire.

2. The electrical receptacle of claim 1, comprising a plurality of receiving terminals for standard blade type electrical components and appliances.

3. The electrical receptacle of claim 2, wherein one of the receiving terminals is connected to or in contact with the ground wiring of the electrical distribution scheme for the purpose of providing a ground path for electrical components.

4. The electrical receptacle of claim 2, wherein one of the receiving terminals is connected to or in contact with the neutral wiring of the electrical distribution scheme for the purpose of providing a neutral path for electrical components.

5. The electrical receptacle of claim 1, wherein said at least one integrated switch comprises a single pole double throw of latching type.

6. The electrical receptacle of claim 1, wherein said at least one integrated switch comprises a double pole double throw of latching type.

7. The electrical receptacle of claim 1, further comprising at least one second switched pole that is connected to an external switching device for user selection.

8. The electrical receptacle of claim 7, wherein said switching device is a wall switch or dimmer switch.

9. The electrical receptacle of claim 1, where an interface device exists on the external surface of the receptacle capable of allowing a user to change the state of said integrated switch.

10. The electrical receptacle of claim 9, wherein said switching device is a pushbutton.

11. The electrical receptacle of claim 11, wherein the device is a toggle button.

12. The electrical receptacle of claim 11, wherein the device is an electrical solenoid.

13. The electrical receptacle of claim 1, further comprising a status indicator to convey the state of the switch.

14. The electrical receptacle of claim 15, wherein said status indicator comprises a light.

15. The electrical receptacle of claim 14, wherein said light is incandescent, or an LED.

16. The electrical receptacle of claim 15, wherein said status indicator comprises a mechanical device that can convey a plurality of states.

17. The electrical receptacle of claim 16, wherein said mechanical device comprises an pop-up button or a rotary dial.

18. The electrical receptacle of claim 1, wherein said electrical receptacle operates at a voltage up to 600V and a current up to 100 amps.

19. The electrical receptacle of claim 18, wherein said voltage ranges from 100 to 250V.

20. The electrical receptacle of claim 18, wherein said current ranges from 10 to 50 amps.
